(19) United States
(12) Patent Application Publication
(10) Pub. No.: US 2014/0081760 A1
(43) Pub. Date: Mar. 20, 2014

(54) METHOD AND APPARATUS FOR DETERMINING CONTENT TO PRESENT ONE OR MORE USERS OF A LOCATION-BASED GROUPING

(71) Applicants: Jukka Antero HOLM, Tampere (FI); Juha Henrik ARRASVUORI, Tampere (FI)

(72) Inventors: Jukka Antero HOLM, Tampere (FI); Juha Henrik ARRASVUORI, Tampere (FI)

(73) Assignee: Nokia Corporation, Espoo (FI)

(21) Appl. No.: 13/621,514

(22) Filed: Sep. 17, 2012

(51) Int. Cl. G06Q 30/02

(52) U.S. Cl. CPC G06Q 30/0261
USPC 705/14.58

(57) ABSTRACT

An approach is provided for determining content data to present to one or more users of a location-based grouping. A group content platform determines at least one location-based grouping of one or more users that have at least one common profile characteristic. The group content platform then determines one or more attributes of the at least one location-based grouping. The group content platform then processes the at least one common profile characteristic, the one or more attributes, or a combination thereof to determine content data to present to at least a subset of the one or more users.

### BACKGROUND

Service providers and device manufacturers (e.g., wireless, cellular, etc.) are continually challenged to deliver content services to consumers efficiently. One area of interest has been the delivery of content services to users. As these services become more proliferated, the content presented to users daily increased even more exponentially. Accordingly, service providers and device manufacturers face significant technical challenges to enabling efficient and targeted delivery of content services to a user or the user's device to encourage dispersion of the content.

### SOME EXAMPLE EMBODIMENTS

Therefore, there is a need for an approach providing content data that can, for instance, dynamically reflect the changing attributes and/or characteristics of a location-based grouping of like-minded users.

According to one embodiment, a method comprises determining at least one location-based grouping of one or more users that have at least one common profile characteristic. The method also comprises determining one or more attributes of the at least one location-based grouping. The one or more attributes include, at least in part, at least one temporal attribute, at least one spatial attribute, at least one social attribute, or a combination thereof. The method further comprises processing the at least one common profile characteristic, the one or more attributes, or a combination thereof to determine content data to present to at least a subset of the one or more users.

According to another embodiment, an apparatus comprises at least one processor, and at least one memory including computer program code for one or more computer programs, the at least one memory and the computer program code configured to, with the at least one processor, cause, at least in part, the apparatus to determine at least one location-based grouping of one or more users that have at least one common profile characteristic. The apparatus is also caused to determine one or more attributes of the at least one location-based grouping. The apparatus is further caused to process and/or facilitate a processing of the at least one common profile characteristic, the one or more attributes, or a combination thereof to determine content data to present to at least a subset of the one or more users.

According to another embodiment, a computer-readable storage medium carries one or more sequences of one or more instructions which, when executed by one or more processors, cause, at least in part, an apparatus to determine at least one location-based grouping of one or more users that have at least one common profile characteristic. The apparatus is also caused to determine one or more attributes of the at least one location-based grouping. The apparatus is further caused to process and/or facilitate a processing of the at least one common profile characteristic, the one or more attributes, or a combination thereof to determine content data to present to at least a subset of the one or more users.

According to another embodiment, an apparatus comprises means for determining at least one location-based grouping of one or more users that have at least one common profile characteristic. The apparatus also comprises means for determining one or more attributes of the at least one location-based grouping. The apparatus further comprises means for processing and/or facilitating a processing of the at least one common profile characteristic, the one or more attributes, or a combination thereof to determine content data to present to at least a subset of the one or more users.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining content data to present to a subset of one or more users of a location-based grouping, according to one embodiment;

FIG. 2 is a diagram of the components of group content platform, according to one embodiment;

FIG. 3 is a flowchart of a process for determining content data to present, according to one embodiment;

FIG. 4A is a flowchart of a process for determining a subset of subset of one or more users of a location-based grouping to present content data, according to one embodiment;

FIG. 4B is an example of a segmentation of a location-based grouping to determine a subset of one or more users to present content data, according to embodiment;

FIGS. 5A-5D are diagrams of user interfaces utilized in the processes of FIGS. 3 and 4A, according to various embodiments;

FIGS. 6A-6D are diagrams of user interfaces utilized in the processes of FIG. 3, according to various embodiments, illustrating another example of content data;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for determining content data to present to a location-based grouping of one or more users are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “location-based grouping” of one or more like-minded users refers to one or more like-minded users that are gathering or are planning to gather in an area, for instance, for a planned or organized event (e.g., a music concert, a movie, a sporting event, a festival, a play, a fair, etc.), an unplanned or impromptu event (e.g., protest, street performance, etc.), and the like. In addition, a location-based grouping can be determined through analysis of profile data pertaining to the user or device, so as to enable a means of predicting and/or determining an event. For example, if it is observed that a number of like-minded users gathered in an area exceed a threshold, this information can be utilized for determining or defining a location-based grouping of one or more like-minded users.

As used herein, “like-minded” users refer to one or more users that share a common “profile characteristic.” As used in the descriptions of the various embodiments described herein, the term “profile characteristic” refers to data associated with the state of a device, state of the device environment, or the user of the device. The profile characteristic, for instance, include recent applications running on the device, recent World Wide Web pages presented on the device, current and recent locations of the device (e.g., from a global positioning system, GPS, a cell tower identifier or a location-based social networking website), weather, ambient light, movement, transportation activity (e.g., driving a car, riding the metro, walking, cycling, etc.), activity interests (e.g., music type, sport played, sport watched, hobbies), contacts, or contact groupings (e.g., family, friends, colleagues, etc.), profile information, among others, or some combination thereof.

As used herein, the terms “content data” refer to multimedia content that can be provided in document, file, token, etc. and that can be presented and/or shared among users. Examples of the multimedia content include music, information associated with an event (e.g., changes in the schedule, new date, availability of vendors, etc.), information about related events, information about local businesses, among others. For example, the new single of the band playing at a concert; the wait time of an amusement ride; the start time of a band playing at a concert, the retailers surrounding the event, among others. In some embodiments, the content data may be presented to receive a discount or rebate related to a transaction for goods and/or services. Although various embodiments are discussed with respect to determining to present content data to and sharing content data among users, it is contemplated that the embodiments described herein are also applicable to any item that can be presented to and/or shared among users including, but not limited, to physical items, electronic items, goods, services, other items in commerce, and the like.

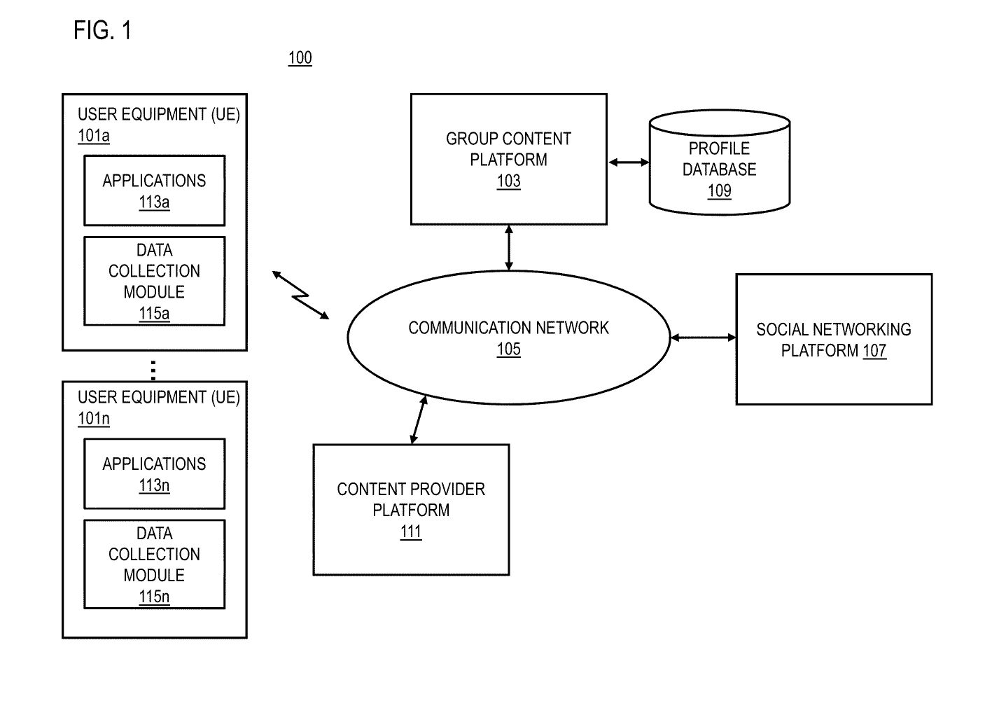

FIG. 1 is a diagram of a system capable of dynamically determining content data to present to a grouping of like-minded users, according to one embodiment. Traditionally, content data, are presented to users on a daily basis based solely on the basic personal information provided by the user and the market(s) selected by the user. However, the content data does not target a location-based grouping of like-minded users. Additionally, the content data are generally configured for use and/or display by a single user. The content data is generally not configured to encourage sharing between users.

To address this problem, a system 100 of FIG. 1 introduces the capability to dynamically determine content data to present to one or more like-minded users of a location-based grouping. In one embodiment, the system 100 determines at least one location-based grouping when a number of one or more like-minded users gather in an area exceed a threshold. In this way, the system 100 can determine an impromptu event and/or organized event by monitoring the profile data of users to determine a location-based grouping.

In one embodiment, the system 100 determines content data to present based on one or more attributes of the grouping and/or profile characteristics of the users of the location-based grouping. As used in the descriptions of the various embodiments described herein, the term “attribute” refers to data that indicates the state of a grouping and/or state of one or more users of the grouping. The attributes, for instance, include spatial (e.g., current and recent locations of a user with respect to the grouping and/or a retailer), temporal (e.g., time, for example, with respect to the starting time, duration, the ending time, etc. of the grouping,), social attributes (e.g., number of and location of contacts associated with a user of the grouping, interests, etc.), among others, or some combination thereof. For example, content data determined to present can be specific to the location of a user with respect to a retailer, the interest of the user, the time, among others things, or a combination thereof. In this way, content data to be presented can be dynamically determined based on the changing composition, distribution, movement, among other things, or a combination thereof, of one or more users included in the grouping. Thereby, targeted content data can be determined to be presented to one or more users of the grouping. Additionally, content data can be delivered to a subset of users likely to share the data among other like-minded users thereby the content data will more efficiently be distributed among users.

In another embodiment, the content data of various embodiments described herein may be supplemented with additional content data to encourage sharing of the content data with another user. In this way, the content data may become more efficiently proliferated throughout among users of the grouping.

As shown in FIG. 1, the system 100 comprises one or more user equipment (UEs) 101a-101n (also collectively referred to as UEs 101) having connectivity to a group content platform 103 via a communication network 105. The UEs 101 may include or have access to one or more applications 113a-113n (collectively referred to as an application 113, or applications 113), which may consist of client programs, services, or the like that may utilize the group content platform 103, the social networking platform 107, or other services, applications, content, etc. available over the communication network 105.

In certain examples, the content provider platform 111 can be a UE 101 operated by a content provider (e.g., event promoter, bands playing at a concert, etc.) to share or otherwise specify content data. For example, a content provider platform 111 and/or UE 101 can be utilized to upload content data to the group content platform 103. In one embodiment, the content provider platform 111 and/or UE 101 can upload parameters (e.g., number of users to directly receive content, bonuses, etc.) associated with the content data. In certain embodiments, the content data may be defined and/or stored locally by the content provider platform 111, the group content platform 103 and/or the UE 101.

In one embodiment, one or profile characteristics as well as attributes of the grouping, the user, the UE 101 or a combination thereof, can be collected and monitored at the group content platform 103. In certain embodiments, the application 113 on the UE 101 can monitor the information (e.g., profile characteristics and/or attributes) associated with a data collection module 115 (shown in FIG. 1 as data collection module 115a-115n, corresponding to the UEs 101a-101n) of the UE 101. For example, the data collection module 115 may utilize applications, services, sensors, etc., to collect such information. Information may include, for instance, location information, camera information, microphone information, weather information, compass information, user calendar information, accelerometer information, etc. In one embodiment, the data collection module 115 may have connectivity to a location determination sensor system, such as a Global Positioning System (GPS) to access GPS satellites to determine e.g., location of the UE 101. The UE 101 may then cause transmission of the collected information (e.g., the profile information, location information etc.) to the platform 103 for processing to determine content data to present to a subset of one or more users. In some embodiment, the group content platform 103 can receive and store information in a user profile associated with the user in a profile database 109. In certain embodiments, the user profile may include an identifier of the user (e.g., a username) and/or an identifier of the UE 101 (e.g., a hardware identifier such as International Mobile Equipment Identity (IMEI), a phone number, an Internet Protocol address, etc.

When the group content platform 103 receives a request to initiate determination of content data, the group content platform 103 queries the profile database 109 to determine one or more like-minded users to whom content data potentially may be presented. In one embodiment, the group content platform 103 evaluates profile characteristics of the users to determine a location-based grouping of one or more like-minded users having at least one common profile characteristic. In certain embodiments, the group content platform 103 queries every user of the group content platform 103 for profile characteristic information to determine a location-based grouping of one or more like-minded users.

In one example, the user may be associated with one or more social networks on one or more social networking platforms 107. Examples of social networking services include networks in which users can interact with other users. Information associated with the social networking platform may be utilized as criteria for the users who are considered to be a part of the location-based grouping and/or the users who are selected to receive content. In certain embodiments, the group content platform 103 can contact the social networking platform (e.g., via an application programming interface) to retrieve social networking information utilized as profile characteristics for determination of location-based group and/or content data to present.

After the group content platform 103 retrieves the profile characteristic information from the user of the UE 101 and determines a location-based grouping, the group content platform 103 can evaluate the one or more attributes of the grouping and/or profile characteristics of the user to determine content data to present.

In one embodiment, one or more attributes include at least one spatial attribute (e.g., current and recent locations of a user with respect to the grouping and/or a retailer), at least one temporal attribute (e.g., time, for example, with respect to the starting time, duration, the ending time, etc. of the grouping,), at least one social attributes (e.g., number of and location of contacts associated with a user of the grouping, interests, etc.), among others, or some combination thereof.

In one embodiment, one or more parameters associated with the content data can be used to determine a subset of one or more users to which content data should be determined to be presented. The one or more parameters include validity period, discount amount, type of discount, number of discounts, conditional access (e.g., based on a number of shares), location of retailer, among others, or a combination thereof. For example, the retail client may want to present content data to certain products during the beginning, middle, and end of the event.

In one embodiment, the group content platform 103 may determine to present content data to at least a subset of one or more like-minded users of the location-based grouping. In another embodiment, the group content platform 103 may determine to present content data to all users of the location-based grouping. In certain embodiments, the group content platform 103 may determine to present different content data to different subset of one or more users of the location-based grouping.

In certain embodiments, at least one or more of the attributes of the grouping and/or profile characteristics of a user can be continuously changing, thus, once the content determination request is received, the group content platform 103 continuously or periodically updates the content data to be presented to at least a subset of one or more users.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UEs 101 and group content platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the group content platform 103 may interact according to a client-server model with the applications 113 of the UEs 101. According to the client-server model, a client process sends a message including a request to a server process, and the server process responds by providing a service (e.g., grouping, social networking, etc.). The server process may also return a message with a response to the client process. Often the client process and the server process execute on different computer devices, called hosts, and communicate via a network using one or more protocols for network communications. The term “server” is conventionally used to refer to the process that provides the service, or the host computer on which the process operates. Similarly, the term “client' is conventionally used to refer to the process that makes the request, or the host computer on which the process operates. As used herein, the term “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

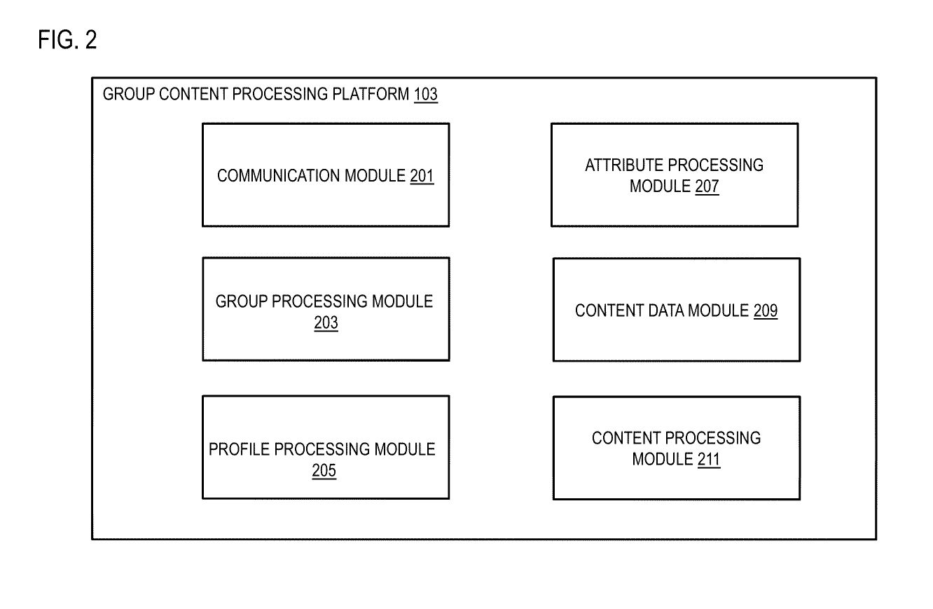

FIG. 2 is a diagram of the components of group content platform 103 according to one embodiment. By way of example, the group content platform 103 includes one or more components for providing content data to be presented to at least a subset of one or more users of a location-based grouping of one or users. It is contemplated that the functions of these components may be combined in one or more components or performed by other components of equivalent functionality. In this embodiment, the group content platform 103 includes a communication module 201, a group processing module 203, a profile processing module 205, an attribute processing module 207, a content data module 209, and a content processing module 211. It is contemplated that all or a portion of the functions of the group content platform 103 may be performed by the application 113 of the UE 101.

In one embodiment, the communication module 201 can be used to communicate with a UE 101 as well as other devices connected on the communication network 105. In one embodiment, the group content platform 103 can send requests for one or more profile characteristics and the like from the UE 101 via the communication module 201 via methods such as internet protocol, MMS, SMS, GPRS, or any other available communication method. By way of example, the UE 101 may further send one or more profile characteristics to the group content platform 103 to determine content data to present.

In one embodiment, the group processing module 203 may receive, determine, and/or monitor a location-based grouping of one or more users. In one embodiment, the group processing module 203 can receive information regarding a potential location-based grouping from one or more participating users. The information can include one or more attributes of the grouping. For example, the group processing module can receive information regarding an upcoming organized event that include type of event (e.g., concert), date, time, one or more names of ticket holders, among other things, and a combination thereof. In another embodiment, the group processing module 203 can determine a location-based grouping when one or more like-minded users have a common profile characteristic. The group processing module 203 can poll for updates to one or more attributes of the grouping, profile characteristics of users, among others, and a combination thereof to determine a location-based grouping of one or more like-minded users.

The profile processing module 205 can receive, determine, and/or monitor one or more profile characteristics associated with a user. In one embodiment, the profile processing module 205 may access a user profile that is associated with the social networking platform 107 and/or the UE 101 by way of the communication module 201. The profile processing module 205 may mine a user profile to determine at least one user profile characteristic, such as, but not limited to, behavioral tendencies, number of contacts, interests, location, and/or preferences that may be used to determine a location-based grouping and/or to determine content data to present and/or subset of one or more users to receive the content data. If one or more profile characteristics of a user changes, the group determination and/or content data can be reevaluated.

On determining a location-based grouping of one or more like-minded users, the attribute processing module 207 can receive, determine, and/or monitor one or more attributes associated with the grouping. The attribute include at least one temporal attribute, at least spatial attribute, and at least one social attribute, among others, or some combination thereof. For example, the attribute processing module 207 can monitor the profile characteristics (e.g., location of one or more users and the UE 101) of users the grouping to estimate the at least one temporal attribute of the grouping. The attribute processing module 207 can determine temporal attributes, based on, for instance, the rate of users joining the location-based grouping to estimate when the location-based grouping potentially begins and when the location-based grouping potentially ends, estimate at least one temporal attribute based on historical data regarding similar location-based groupings (e.g., duration of an event), the weather to estimate when the location-based grouping may end, among others, or some combination thereof.

In one embodiment, the attribute processing module 207 can monitor the profile characteristics (e.g., location of one or more users and the UE 101) of users to determine one or more spatial attributes of the location-based grouping. In one embodiment, at least one spatial characteristic may be based distance of a user to at least one landmark (e.g., the retailer, the concert stage, etc.) at the location-based grouping.

In one embodiment, the attribute processing module 207 can monitor the profile characteristics (e.g., number of contacts in their social networks) of users to determine one or more social attributes of the location-based grouping. In one embodiment, the attribute processing module 207 may determine a number of contacts of a user that are among the location-based grouping.

The content data module 209 may store the content data to present. In one embodiment, the content data module 209 may store parameters associated with the content data. The parameters may include validity period, type of content, number of users to directly receive content, conditional access (e.g., based on a number of shares), location of content provider, among others, or a combination thereof.

In one embodiment, the content processing module 211 may process one or more attributes of the grouping, one or more profile characteristics, and/or combination thereof to determine content data to present at least one subset of users. For example, content data pertaining to a new song of a band may be determined to be presented when the band or a band of a similar genre that plays at a concert; to availability of an amusement ride at an amusement park to rain products may be determined to be presented when the forecast predicts rain, among others, or a combination thereof.

In one embodiment, the content processing module 211 may monitor the content data to determine whether if additional and/or modified content data should be presented to one or more users. For example, the content processing module 211 may present additional content data if a user shares the content data with another user. In one embodiment, the content processing module 211 may cause the content data to change appearance upon sharing. In certain embodiments, the content processing module 211 may present additional content data (e.g., additional discounts, another song, free products, etc.) if a user shares the content data with another user. In one embodiment, the additional content may be presented if the user and the other user have at least one matching predetermined profile characteristic (e.g., same device code, first or second name, etc.), lottery, among other things, or some combination thereof.

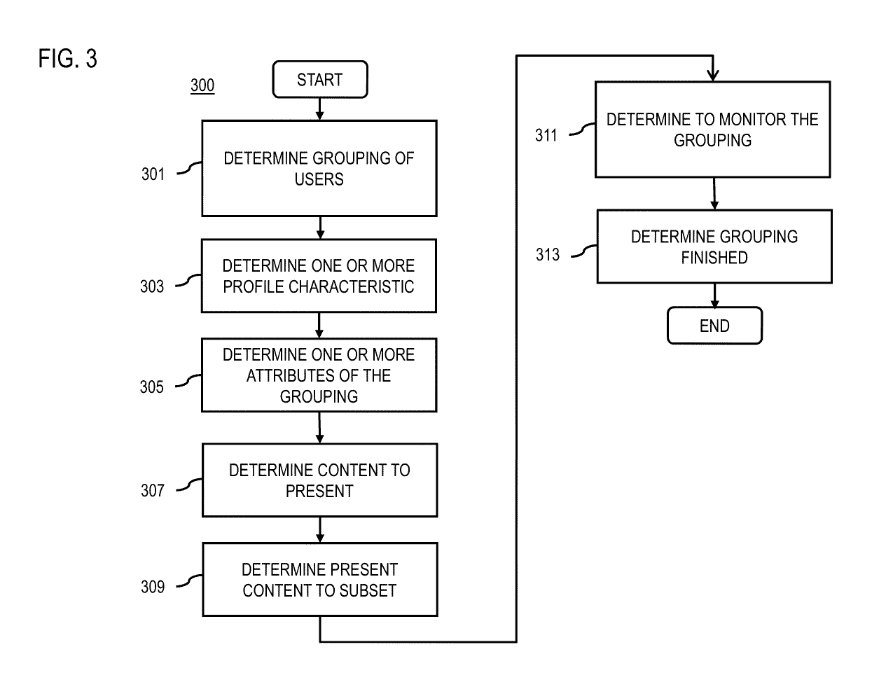

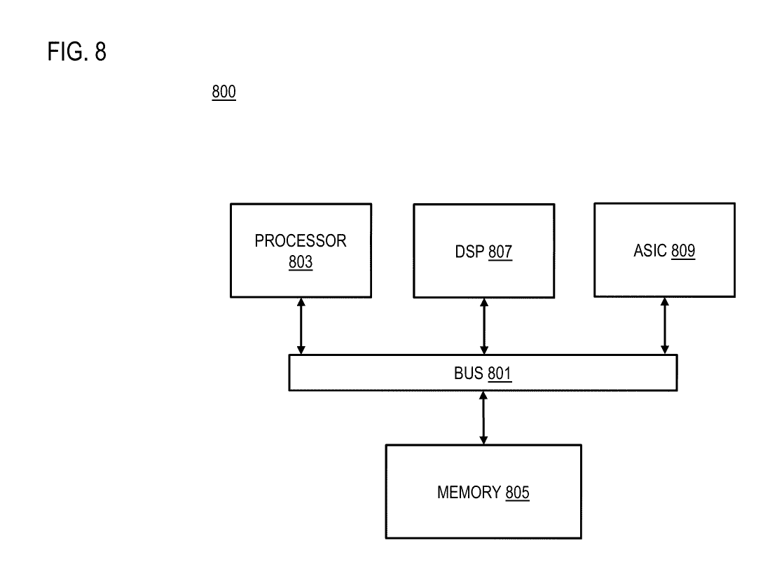

FIG. 3 is a flowchart of a process for determining content data to present, according to one embodiment. In one embodiment, the group content platform 103 and/or an application 113 of the UE 101 performs the process 300 and is implemented in, for instance, a chip set including a processor and a memory as shown in FIG. 8. Throughout this process, the group content platform 103 is referred to as completing various portions of the process 300, however it is understood that the UE 101 can perform some of and/or all of the process steps.

In step 301, the group content platform 103 determines a location-based grouping of one or more users. In one embodiment, the determination of the location-based grouping of one or more users can be in response to a request to determine a grouping. The request can be received from one or more retailers. In some embodiments, the request may include at least one common profile characteristic of a user that should define the location-based grouping.

The group content platform 103 then determines one or more profile characteristics of like-minded users (step 303). In one embodiment, the determination of a location-based grouping may be based, at least in part, on the determination of one or more profile characteristics. In certain embodiments, the location-based grouping of one or more like-minded users may be provided in the request. In certain embodiments, the users that have at least one common profile characteristic may be determined to be a part of the location-based grouping.

After the location-based grouping of users has been determined, the group content platform 103 determines one or more attributes of the grouping (step 305). The group content platform 103 then causes, at least in part, processing of one or more attributes and/or profile characteristic of the user to determine content data to present (step 307). In one embodiment, the group content platform 103 can determine more than one content data to be presented.

At step 309, the group content platform 103 determines to present content data to a subset of one or more users the location-based grouping to which content data should be presented. The group content platform 103 causes, in at least part, monitoring one or more attributes of the grouping, one or more the profile characteristics of the grouping, the content data presented, and/or some combination thereof (step 311). In one embodiment, the group content platform 103 may then determine to update the attributes of the location-based grouping and/or content data to present.

The group content platform 103 may continue to attributes of the grouping, one or more the profile characteristics of the grouping, the content data presented until the location-based grouping has finished (step 313). In one embodiment, the group content platform 103 determines that the location-based grouping has ended, for instance, based on temporal attributes, for instance, when a number of like-minded users that have exited and/or rate of number of like-minded users exiting an area exceeded a threshold, when a rate of like-minded users entering an area is below a threshold, when the organized event has planned to end, among others, or a combination thereof.

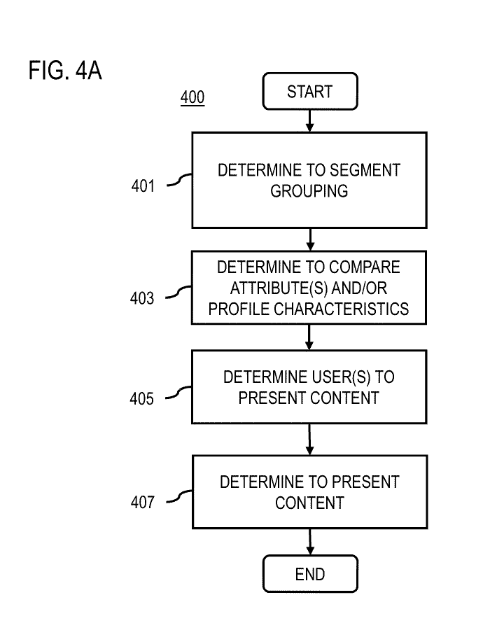

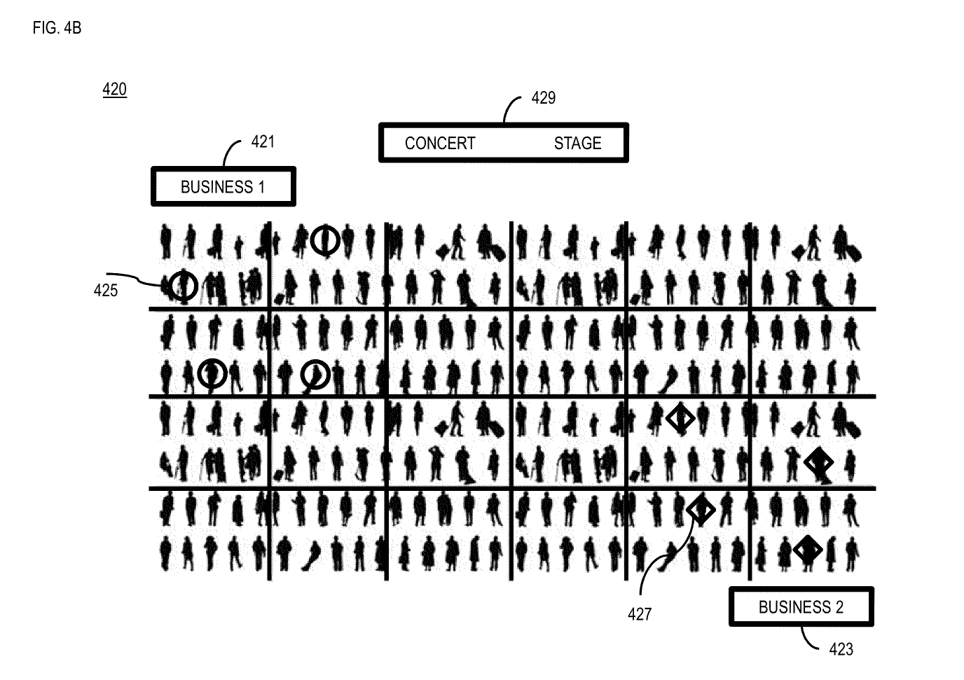

FIG. 4A is a flowchart of a process for determining content data (step 307) to present to a subset of one or more users based on the processing of the one or more attributes and/or profile characteristics, according to one embodiment. In one embodiment, the group content platform 103 performs the process 400 and is implemented in, for instance, a chip set including a processor and a memory as shown in FIG. 8. In addition or alternatively, the applications 113 may perform all or a portion of the process 400.

In one embodiment, a parameter of the content data may include a predetermined number of users to which content data should be presented. In this example, the group content platform 103 may optionally determine to segment the users of the location-based grouping into at least one segment based on the location of the users (step 401). For example, FIG. 4B depicts, in a diagram 420, an example of a plurality of users of a location-based grouping divided into a plurality of segments, wherein each segment may include a plurality of users.

The group content platform 103 may then determine to compare the one or more attributes and/or one or more profile characteristics (step 403) of the users having at least one common characteristic to determine at least one user to which the content data should be presented. The comparison may be based on at least the temporal attribute, the social attribute, the social attribute, among others, or some combination thereof. For example, the timing of the event and/or movements of the users may be compared. The users may be compared to determine at least one user who has the most contacts, the most contacts in a predetermined vicinity of the user, the most contacts among the location-based grouping, etc. The users may be compared based on distance to one or more retail locations. In some embodiments, certain subsets or segments of one or more users (e.g., for example, those closest to retailer) may be compared.

Next, the group content platform 103 may determine at least one subset of one or more users to present content data (step 405). In some embodiments, the group content platform may determine to present different content data to at least two different subsets of one or more users.

For example, as shown in FIG. 4B, the spatial attributes of the location-based grouping may be compared to determine a subset of users to present content data. In this example, the group content platform 103 determines the distance between the users and businesses 1 and 2 (421 and 423, correspondingly, in FIG. 4B) is compared. In one embodiment, users in certain segments may be compared to determine the one or more or users to present content data. In another embodiment, the group content platform determines the users and an event landmark, such as concert stage 429. In certain embodiments, the users may be further compared according to the other attributes, such as at least one temporal attribute and/or social attribute, and profile characteristics. The group content platform 103 then determines the users to present content data. As shown in FIG. 4B, the group content platform 103 determined that content data regarding the business 1 (421) should be presented to users 425 (surrounded by a circle) and that content data regarding the business 2 (423) should be presented to users 427 (surrounded by a diamond).

The group content platform 103 may then determine to present content data (step 407).

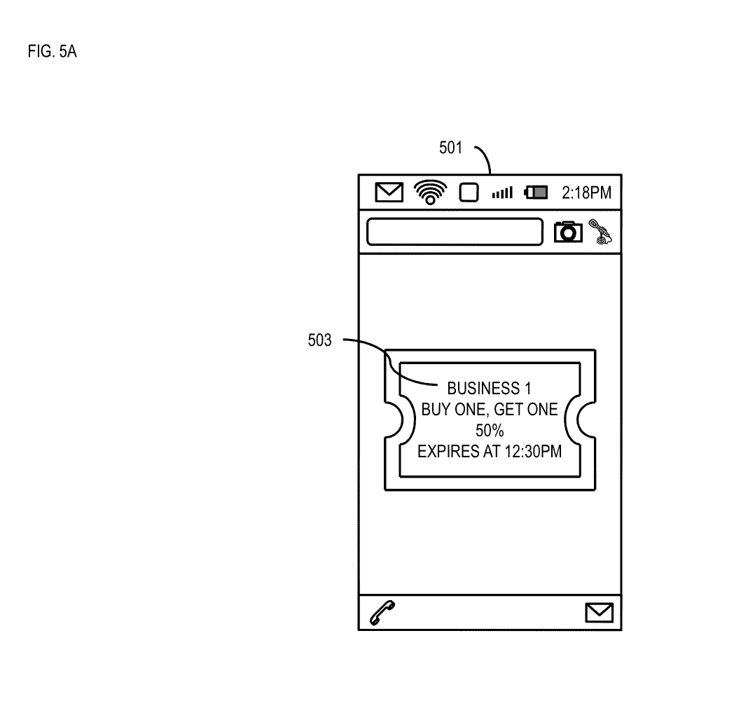

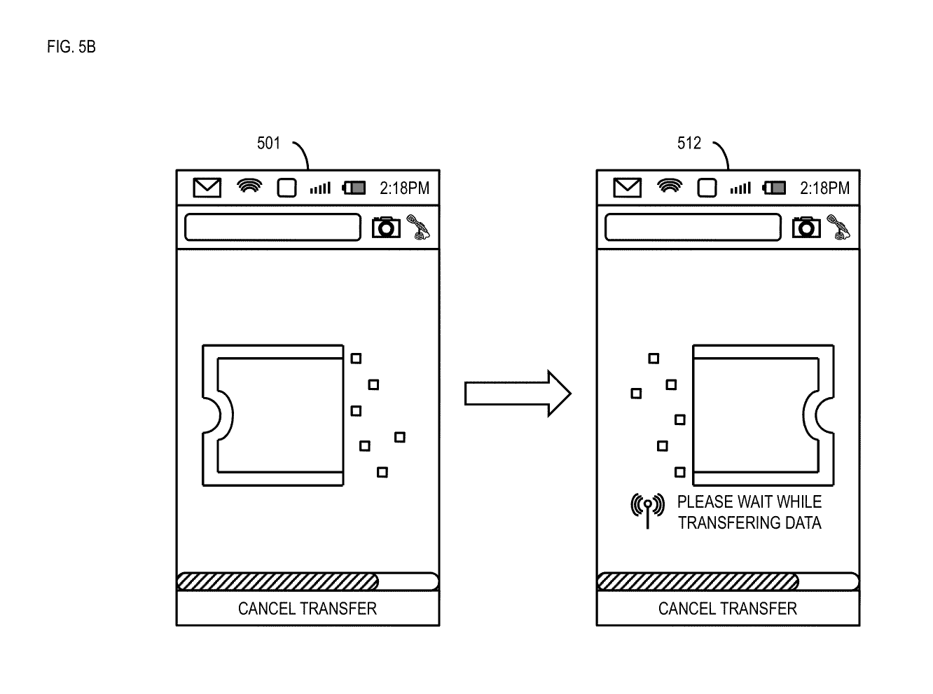

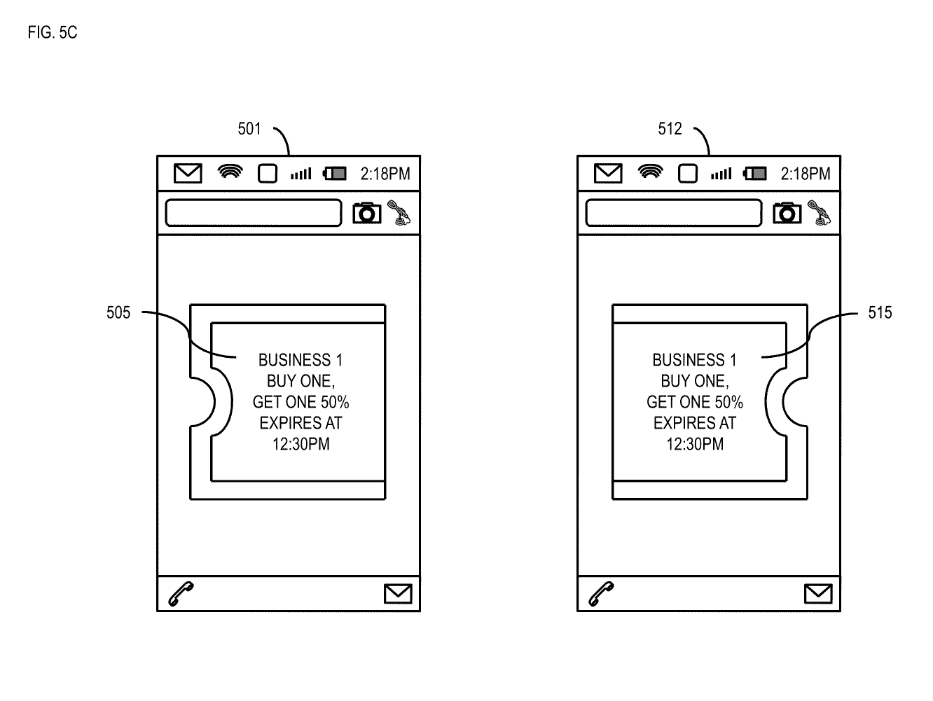

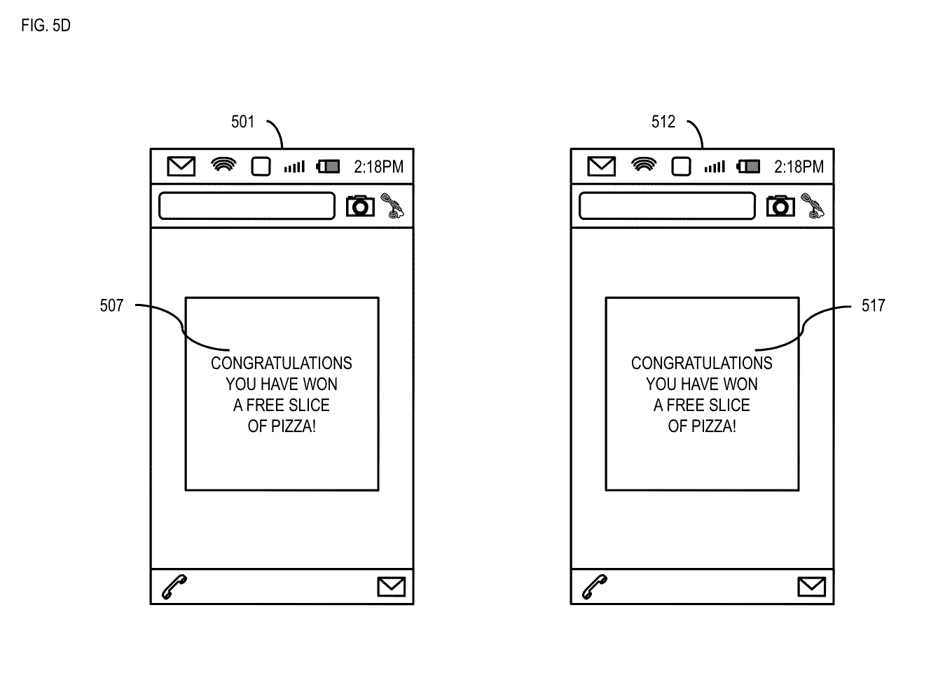

FIGS. 5A-5D are diagrams of user interfaces utilized in the processes of FIG. 3, according to various embodiments. FIG. 5A shows an example of a user interface with content data, according to various embodiments. In this example, a user via user interface 501 received content data 503 regarding the business 1 (421 in FIG. 4B).

In one embodiment, as shown in FIG. 5B, the user via the user interface 501 may share the content data 503 with another user via the another user's user interface 512. In certain embodiments, as shown in FIG. 5C, after exchanging the content data, the content data 503 may change or be modified to content data 505 having a different appearance. The appearance may depend on a theme of the location-based grouping. In this example, the content data 503 is originally presented as a full ticket. As a result of the sharing of the content data 503, the appearance of the content data 503 is changed to a half-ticket. In one embodiment, the content data 505 may have the same appearance as the content data 515 presented on the another user's user interface 512.

In one embodiment, the number of shares of the content data may be limited. For example, the content data may include a marking from the first user who shared it. In other embodiments, the amount of discount may depend on how many times the coupon is shared.

In one embodiment, additional content data may be presented to encourage or motivate sharing and receiving content data. The additional content may be determined to be presented based on, for instance, after a number of shares, a lottery, common profile characteristic, the distance between shares, device characteristics (e.g., International Mobile Equipment Identity (IMEI) code), among others, or some combination thereof. The additional content data include prizes, additional discounts, free products, additional songs and/or information associated with an entertainer, among other things, or some combination thereof. FIG. 5D depicts the user interfaces 501 and 512 on which additional content data 507 and 517, respectively, is presented. In this example, the additional content data 507 and 517 is for a free product, which is represented by a free slice of pizza. Although in this example embodiment the additional content is the same on both user interfaces, the additional content may be different on one user interface (e.g. the user interface 501) compared to another interface (e.g. the user interface 512). The difference may depend e.g. on user preferences determined e.g. in a user profile (in general, user profiles are well known in the art). The difference may also depend on a different context of the users of corresponding user interfaces. For example, user of the user interface 501 may recently have performed a search function for locating a pizza restaurant, but user of the user interface 512 has a preference for vegetarian food. As a result, the example additional content presented on the interface 501 could still be the free slice of pizza, but the user interface 512 could have additional content corresponding to e.g. 50% discount on a dish of vegetarian food.

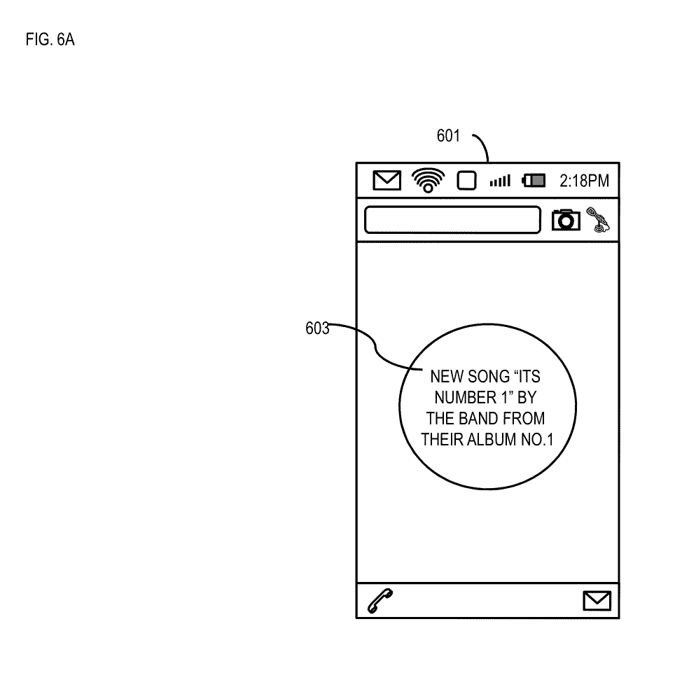

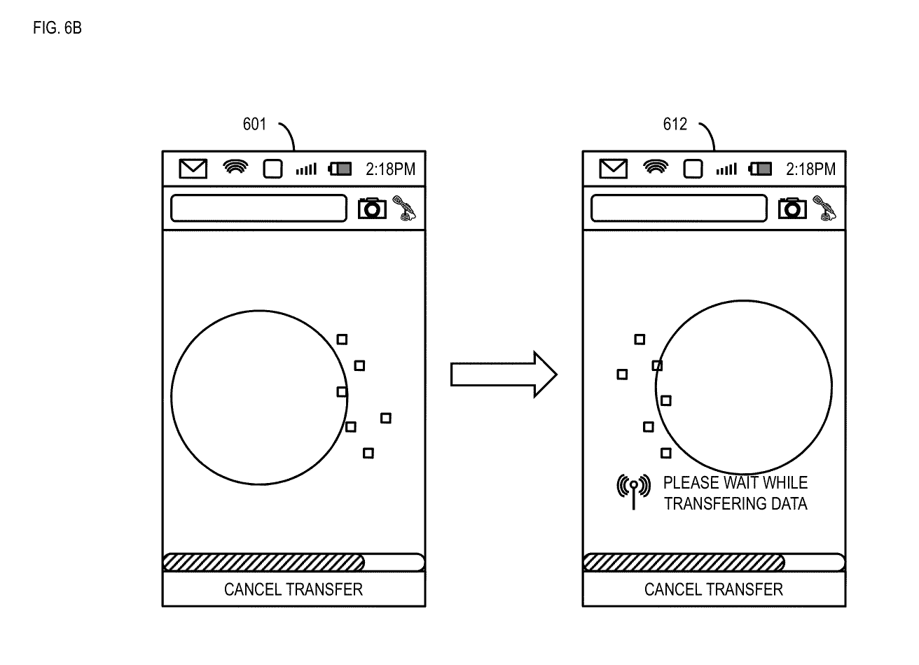

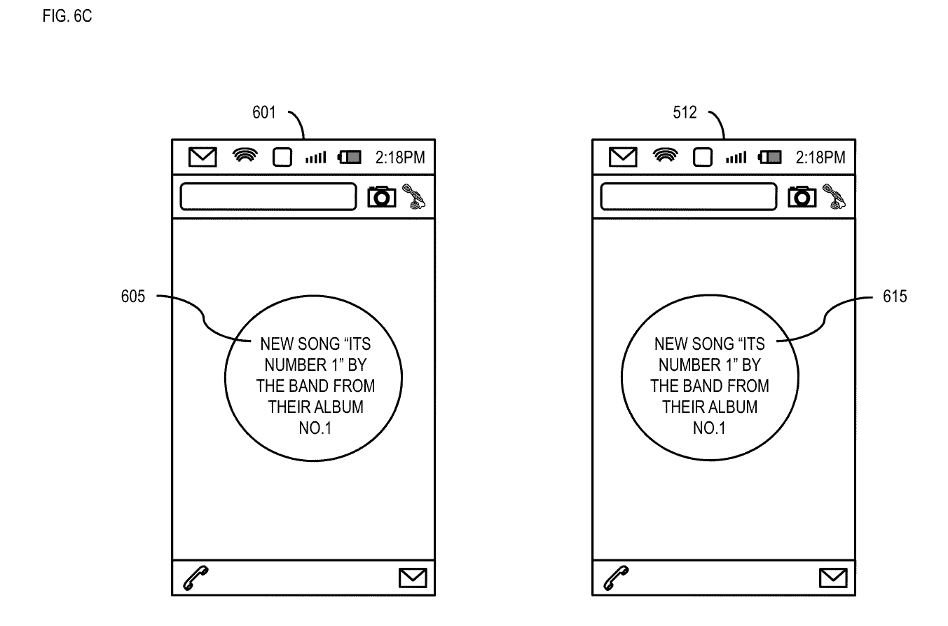

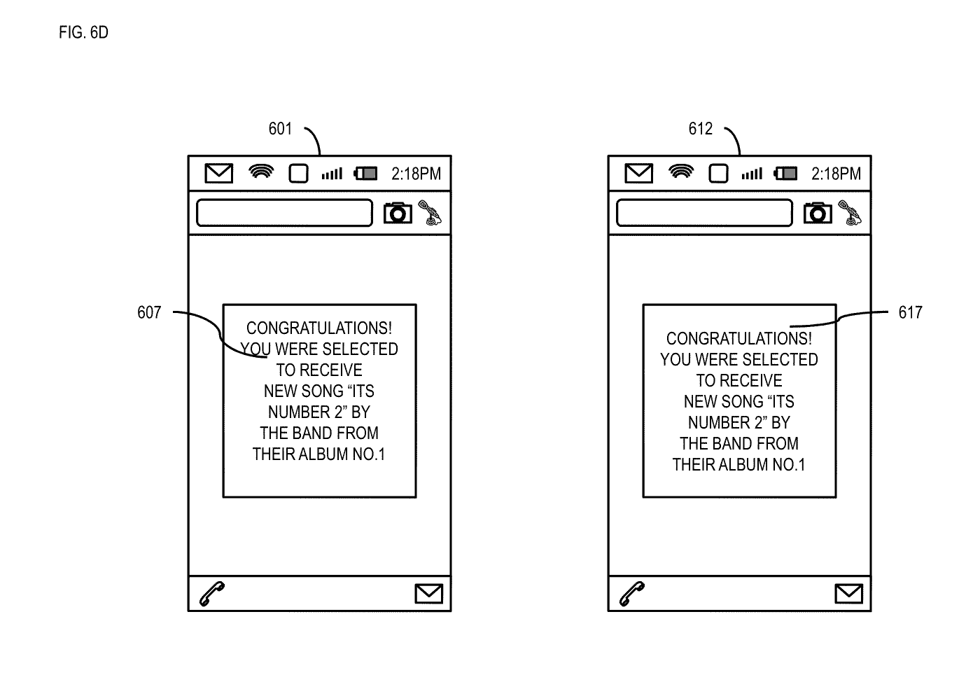

FIGS. 6A-6D illustrate another example of diagrams of user interfaces utilized in the processes of FIG. 3, according to various embodiments. FIG. 6A shows an example of a user interface with content data, according to various embodiments. In this example, a user via user interface 601 received content data 603 regarding a new song from “The Band.”

In one embodiment, as shown in FIG. 6B, the user via the user interface 601 may share the content data 603 with another user via the another user's user interface 612. In certain embodiments, as shown in FIG. 6C, after exchanging the content data, the content data 603 may change or be modified to content data 605 having a different appearance. The appearance may depend on the theme of the location-based grouping. In this example, the content data 603 is originally presented as a circular item, imitating e.g. the general appearance of a physical audio record such as a digital audio compact disc (also known as a CD, CDDA or CD-DA). As a result of the sharing of the content data 603, the appearance of the content data 603 could be changed to a half-record, in a similar way to the example in FIG. 5C of the half-ticket. In one embodiment, and as shown in FIG. 6C, the content data 605 may have the same appearance as the content data 615 presented on the user interface 612.

FIG. 6D depicts the user interfaces 601 and 612 on which additional content data 607 and 617, respectively, is presented. In this example, the additional content data 607 and 617 is for another new song by “The Band”.

The processes described herein for determining content to present to a subset of one or more users of a location-based grouping may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

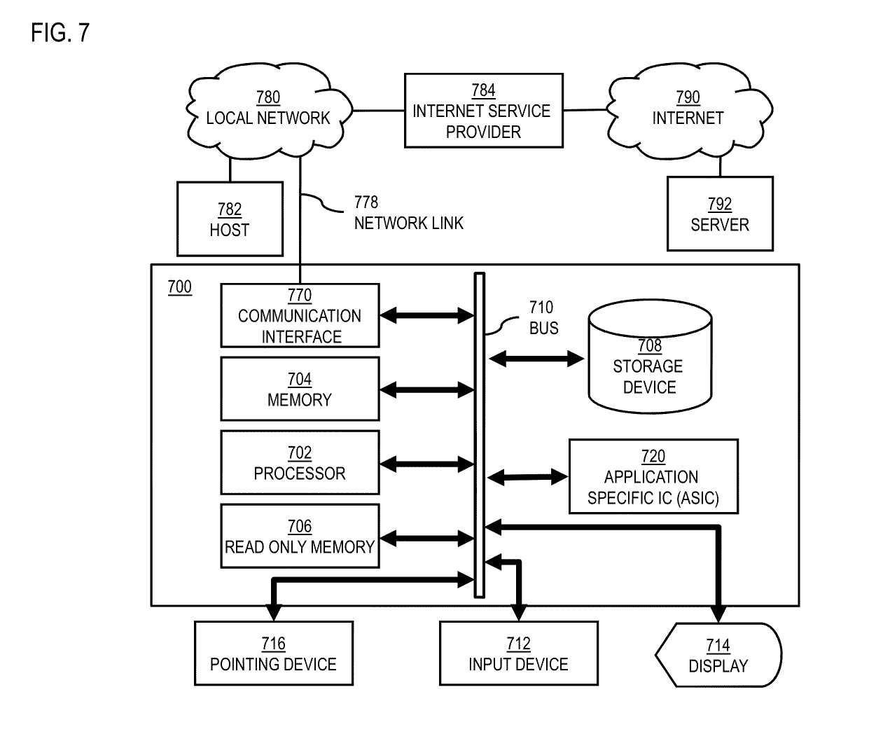

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to present to a subset of one or more users of a location-based grouping as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of to determine content data to present to at least a subset of one or more users of a location-based grouping.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to determine content data to present to a subset of one or more users of a location-based grouping. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for determining content data to present to a subset of one or more users of a location-based grouping. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions to determine content data to present to a subset of one or more users of a location-based grouping, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for determining content data to present to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to determine content data to present to at least one subset of one or more users of a location-based grouping as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of determining content data to present to at least one subset of one or more users of a location-based grouping.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to determine content data to present to at least one subset of one or more users of a location-based grouping. The memory 805 also stores the data associated with or generated by the execution of the inventive steps.

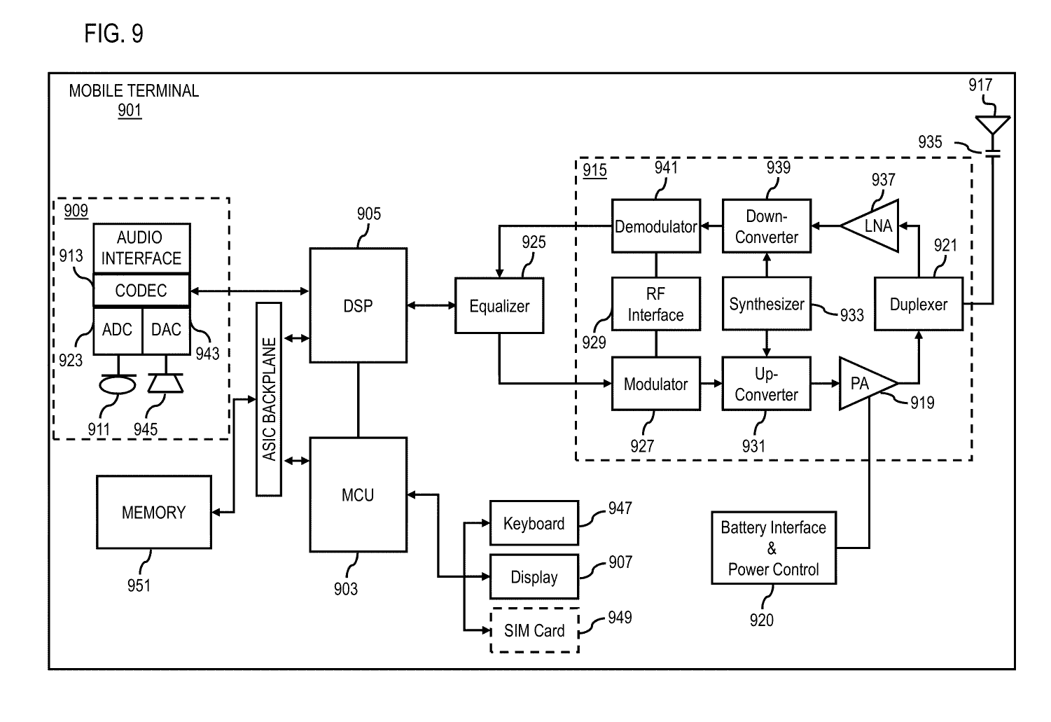

FIG. 9 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of determining content data to present to at least one subset of one or more users of a location-based grouping. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of determining content data to present to at least one subset of one or more users of a location-based grouping. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to determine content data to present to at least one subset of one or more users of a location-based grouping. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
at least one determination of at least one location-based grouping of one or more users that have at least one common profile characteristic;
at least one determination of one or more attributes of the at least one location-based grouping, wherein the one or more attributes include, at least in part, at least one temporal attribute, at least one spatial attribute, at least one social attribute, or a combination thereof; and
a processing of the at least one common profile characteristic, the one or more attributes, or a combination thereof to determine content data to present to at least a subset of the one or more users.

2. A method of claim 1, wherein the at least one location-based grouping is associated with at least one event.

3. A method of claim 1, wherein the at least one spatial attribute includes in at least in part, a spatial relationship of at least user with respect to the grouping, a retailer and/or a combination thereof.

4. A method of claim 1, wherein the at least one temporal attribute includes in at least in part, a rate of users joining the at least one location-based grouping, a rate of users departing the at least one location-based grouping, an estimated duration of the at least one location-based grouping, or a combination thereof.

5. A method of claim 1, wherein the at least one social attribute includes, in at least in part, a number of contacts associated with a social network, at least one social graph, or a combination thereof associated with a user.

6. A method of claim 1, wherein the (1) data and/or (2) information and/or (3) at least one signal are further based, at least in part, on the following:
a monitoring of the one temporal attribute, at least one spatial attribute, at least one social attribute, or a combination thereof; and
a determination to present the content data to at least a subset of the one or more users based, at least in part, on the monitoring.

7. A method of claim 1, wherein the (1) data and/or (2) information and/or (3) at least one signal are further based, at least in part, on the following:
a monitoring of at least one share of the content data between users; and
a processing and/or a facilitation of a processing of the at least one common profile characteristic, the one or more attributes, or a combination thereof to determine a modification and/or additional content data to present to at least a subset of the one or more users based on the monitoring.

8. A method of claim 1, wherein the (1) data and/or (2) information and/or (3) at least one signal are further based, at least in part, on the following:
a monitoring of the content data against a number of shares of the content data between users; and
at least one determination to modify the content data based on at least in part, a number of shares between users, a profile characteristic of at least one of the users, or a combination thereof.

9. A method of claim 1, wherein the (1) data and/or (2) information and/or (3) at least one signal are further based, at least in part, on the following:
a selection of the subset of the one or more users based, in at least in part, on the at least one common profile characteristic, the one or more attributes, or a combination thereof.

10. A method of claim 1, wherein the (1) data and/or (2) information and/or (3) at least one signal are further based, at least in part, on the following:
a processing of the content data, to promote sharing of the content data between users based on, in at least in part, on the at least one common profile characteristic, the one or more attributes, or a combination thereof.

11. An apparatus comprising:
at least one processor; and
at least one memory including computer code for one or more programs,
the at least one memory and the computer program code configured to, with the at least one processor, cause the apparatus to perform at least the following:
determine at least one location-based grouping of one or more users that have at least one common profile characteristic;
determine one or more attributes of the at least one location-based grouping, wherein the one or more attributes include, at least in part, at least one temporal attribute, at least one spatial attribute, at least one social attribute, or a combination thereof; and
process and/or facilitate a processing of the at least one common profile characteristic, the one or more attributes, or a combination thereof to determine content data to present to at least a subset of the one or more users.

12. An apparatus of claim 11, wherein the at least one location-based grouping is associated with at least one event.

13. An apparatus of claim 11, wherein the at least one spatial attribute includes in at least in part, a spatial relationship of at least user with respect to the grouping, a retailer and/or a combination thereof.

14. An apparatus of claim 11, wherein the at least one temporal attribute includes in at least in part, a rate of users joining the at least one location-based grouping, a rate of users departing the at least one location-based grouping, an estimated duration of the at least one location-based grouping, or a combination thereof.

15. An apparatus of claim 11, wherein the at least one social attribute includes, in at least in part, a number of contacts associated with a social network, at least one social graph, or a combination thereof associated with a user.

16. An apparatus of claim 11, wherein the apparatus is further caused to:
cause, at least in part, monitoring of the one temporal attribute, at least one spatial attribute, at least one social attribute, or a combination thereof; and
determine to present the content data to at least a subset of the one or more users based, at least in part, on the monitoring.

17. An apparatus of claim 11, wherein the apparatus is further caused to:
cause, in at least in part, monitoring of at least one sharing of the content data between users; and
process and/or facilitate a processing of the at least one common profile characteristic, the one or more attributes, or a combination thereof to determine a modification and/or additional content data to present to at least a subset of the one or more users based on the monitoring.

18. An apparatus of claim 11, wherein the apparatus is further caused to:
cause, at least in part, monitoring of the content data against a number of shares of the content data between users; and
determine to modify the content data based on at least in part, a number of shares between users, a profile characteristic of at least one of the users, or a combination thereof.

19. An apparatus of claim 11, wherein the apparatus is further caused to:
cause, at least in part, a selection of the subset of the one or more users based, in at least in part, on the at least one common profile characteristic, the one or more attributes, or a combination thereof.

20. An apparatus of claim 11, wherein the apparatus is further caused to:
cause, at least in part, processing of the content data, to promote a sharing of the content data between users based, in at least in part, on the at least one common profile characteristic, the one or more attributes, or a combination thereof.

21-48. (canceled)
